(19) United States
(12) Patent Application Publication
(10) Pub. No.: US 2024/0135264 A1
(43) Pub. Date: Apr. 25, 2024

(54) DEVICE, SYSTEM AND METHOD FOR GENERATING TRAINED MODELS TO GENERATE PROVIDER OBJECTS

(71) Applicant: AMADEUS S.A.S., Biot (FR)

(72) Inventors: Corinne LANDRA, Opio (FR); Gilles Louis Claude GAGNIARD, Roquefort Les Pins (FR); Nicolas Michel MONTEIL, Villeneuve-Loubet (FR)

(21) Appl. No.: 17/973,079

(22) Filed: Oct. 24, 2022

(51) Int. Cl. G06Q 10/02; G06Q 30/06

(52) U.S. Cl. CPC G06Q 10/02; G06Q 30/0631

(57) ABSTRACT

A device, system and method for generating trained models to generate provider objects is provided. A computing device receives a set of associated provider objects, each provider object representing a respective group of one or more items provided to a client device for selection at successive times; successive provider objects, following a first provider object, comprising at least one item selected at the client device from one or more previous provider objects. The computing device generates from the set of associated provider objects, a trained model configured to generate one or more new provider objects. The computing device receives a provider object request from one or more client devices and, in response, generates, using the trained model, the one or more new provider objects, and provides, to the one or more client devices, one or more of the new provider objects.

### FIELD

The specification relates generally to intermediation between devices, and specifically to a device, system and method for generating trained models to generate provider objects.

### BACKGROUND

The provision of various products, including for example travel-related goods and services (e.g., flights, hotel reservations, and the like), typically requires various discrete entities to exchange data defining various aspects of the products. Examples of such entities, in the context of travel-related products, include airlines, travel agencies, end users, reservation systems, and the like. Although such entities may be configured to exchange data according to a standardized format (e.g., according to the eXtensible Markup Language (XML)-based New Distribution Capability (NDC) standard in the context of travel-related products), they may nonetheless employ different mechanisms to initiate the exchange of data. Furthermore, generation of provider objects may be challenging as, especially in the NDC standard, the provider objects may be customized to a high degree, but such customization may lead to challenges that may result in waste of processing resources.

### SUMMARY

A first aspect of the present specification provides a method comprising: receiving, at one or more computing devices, a set of associated provider objects, each provider object, of the set of associated provider objects, representing a respective group of one or more items provided to a client device for selection at successive times; successive provider objects, following a first provider object, comprising at least one item selected at the client device from one or more previous provider objects; and generating, at the one or more computing devices, from the set of associated provider objects, a trained model configured to generate one or more new provider objects; receiving, at the one or more computing devices, a provider object request from one or more client devices; in response to receiving the provider object request, generating, at the one or more computing devices, using the trained model, the one or more new provider objects; and providing, from the one or more computing devices, to the one or more client devices, one or more of the new provider objects.

At the first aspect, the set of associated provider objects may comprise respective provider objects provided to the client device at different steps of a computing-process flow implemented by the client device.

At the first aspect, the set of associated provider objects may comprise respective provider objects provided to the client device at different steps of a computing-process flow implemented by the client device, the set of associated provider objects associated with each other using one or more identifiers.

At the first aspect, at least one item selected at the client device from one or more previous provider objects may comprise a first item selected at the client device from one or more previous provider objects, and at least one of the successive provider objects, following the first provider object, may further comprise: the first item selected at the client device from one or more previous provider objects; and one or more further items for selection at the client device.

At the first aspect, the trained model may comprise one or more of a machine learning model, a classifier of the machine learning model and a neural network layer.

The method of the first aspect may further comprise: receiving a plurality of sets of respective associated provider objects, including the set of associated provider objects; and generating the trained model from the plurality of sets of respective associated provider objects.

At the first aspect, the trained model may be further configured to generate one or more of: a respective first provider object of a new set of the one or more new provider objects; and one or more further successive provider objects of the new set of the one or more new provider objects.

At the first aspect, the trained model may be further configured to generate one or more new groups of one or more respective items for incorporation into one or more of the new provider objects.

A second aspect of the present specification provides a device comprising: a communication interface; and a controller configured to: receive, via the communication interface, a set of associated provider objects, each provider object, of the set of associated provider objects, representing a respective group of one or more items provided to a client device for selection at successive times; successive provider objects, following a first provider object, comprising at least one item selected at the client device from one or more previous provider objects; and generate, from the set of associated provider objects, a trained model configured to generate one or more new provider objects; receive, via the communication interface, a provider object request from one or more client devices; in response to receiving the provider object request, generate, at the one or more computing devices, using the trained model, the one or more new provider objects; and provide, via the communication interface, to the one or more client devices, one or more of the new provider objects.

At the second aspect, the set of associated provider objects may comprise respective provider objects provided to the client device at different steps of a computing-process flow implemented by the client device.

At the second aspect, the set of associated provider objects may comprise respective provider objects provided to the client device at different steps of a computing-process flow implemented by the client device, the set of associated provider objects associated with each other using one or more identifiers.

At the second aspect, at least one item selected at the client device from one or more previous provider objects may comprise a first item selected at the client device from one or more previous provider objects, and at least one of the successive provider objects, following the first provider object, may further comprise: the first item selected at the client device from one or more previous provider objects; and one or more further items for selection at the client device.

At the second aspect, the trained model may comprise one or more of a machine learning model, a classifier of the machine learning model and a neural network layer.

At the second aspect, the controller may be further configured to: receive a plurality of sets of respective associated provider objects, including the set of associated provider objects; and generate the trained model from the plurality of sets of respective associated provider objects.

At the second aspect, the trained model may be further configured to generate one or more of: a respective first provider object of a new set of the one or more new provider objects; and one or more further successive provider objects of the new set of the one or more new provider objects.

At the second aspect, the trained model may be further configured to generate one or more new groups of one or more respective items for incorporation into one or more of the new provider objects.

A third aspect of the present specification provides a non-transitory computer-readable medium storing a computer program, wherein execution of the computer program is to implement a method comprising: receiving, at one or more computing devices, a set of associated provider objects, each provider object, of the set of associated provider objects, representing a respective group of one or more items provided to a client device for selection at successive times; successive provider objects, following a first provider object, comprising at least one item selected at the client device from one or more previous provider objects; and generating, at the one or more computing devices, from the set of associated provider objects, a trained model configured to generate one or more new provider objects; receiving, at the one or more computing devices, a provider object request from one or more client devices; in response to receiving the provider object request, generating, at the one or more computing devices, using the trained model, the one or more new provider objects; and providing, from the one or more computing devices, to the one or more client devices, one or more of the new provider objects.

At the third aspect, the set of associated provider objects may comprise respective provider objects provided to the client device at different steps of a computing-process flow implemented by the client device.

At the third aspect, the set of associated provider objects may comprise respective provider objects provided to the client device at different steps of a computing-process flow implemented by the client device, the set of associated provider objects associated with each other using one or more identifiers.

At the third aspect, at least one item selected at the client device from one or more previous provider objects may comprise a first item selected at the client device from one or more previous provider objects, and at least one of the successive provider objects, following the first provider object, may further comprise: the first item selected at the client device from one or more previous provider objects; and one or more further items for selection at the client device.

At the third aspect, the trained model may comprise one or more of a machine learning model, a classifier of the machine learning model and a neural network layer.

The method of the third aspect may further comprise: receiving a plurality of sets of respective associated provider objects, including the set of associated provider objects; and generating the trained model from the plurality of sets of respective associated provider objects.

At the third aspect, the trained model may be further configured to generate one or more of: a respective first provider object of a new set of the one or more new provider objects; and one or more further successive provider objects of the new set of the one or more new provider objects.

At the third aspect, the trained model may be further configured to generate one or more new groups of one or more respective items for incorporation into one or more of the new provider objects.

### BRIEF DESCRIPTIONS OF THE DRAWINGS

For a better understanding of the various examples described herein and to show more clearly how they may be carried into effect, reference will now be made, by way of example only, to the accompanying drawings, in which:

FIG. 1 depicts a system for generating trained models to generate provider objects, according to non-limiting examples.

FIG. 2 depicts a computing device for generating trained models to generate provider objects, according to non-limiting examples.

FIG. 3 depicts a computing-process flow of the system of FIG. 1, according to non-limiting examples.

FIG. 4 depicts the system of FIG. 1 in further detail, according to non-limiting examples.

FIG. 5 depicts examples of a set of associated provider objects, according to non-limiting examples.

FIG. 6 depicts a flowchart of a method for generating trained models to generate provider objects, according to non-limiting examples.

FIG. 7 depicts the system of FIG. 4 implementing aspects of a method for generating trained models to generate provider objects, according to non-limiting examples.

FIG. 8 depicts the system of FIG. 4 implementing further aspects of a method for generating trained models to generate provider objects, according to non-limiting examples.

### DETAILED DESCRIPTION

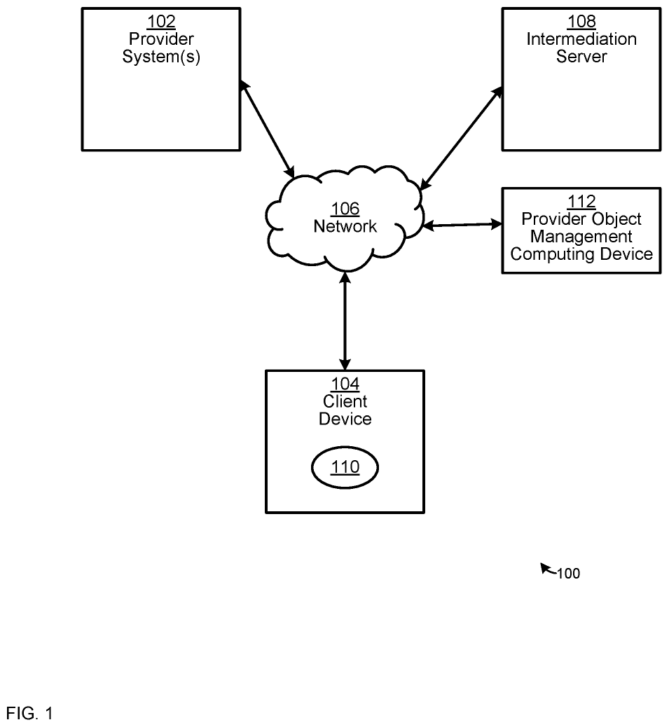

FIG. 1 depicts a system 100 for intermediation between a provider system (e.g., one or more servers or other suitable computing devices), and a client device. Provider objects, in the examples discussed herein, may comprise provider objects and/or data records, which correspond to products and/or items, such as travel-related goods and services (e.g., flights, hotel reservations, car rentals and the like), provided by a provider system. More specifically, the products and/or items discussed in the examples below may be flight tickets and related services (e.g., limo pickup services, excursions at a destination, baggage check services, in-flight food, entertainment, pet-related services, and the like). However, as will be apparent to those skilled in the art, the systems and methods discussed below can also be applied to various other types of data objects and/or items including, but not limited to, data objects correspond to any suitable products and/or any suitable items available (e.g., for purchase, and the like) from any suitable website, and the like.

Delivery of the items mentioned above is typically controlled by a provider entity, such as an airline in the case of the items discussed in connection with the travel-industry related examples provided herein. The system 100 includes one or more provider systems 102 (e.g., one or more servers or other suitable computing devices), which in this example is operated by one or more provider entities. The system 100 can include a plurality of client devices 104, although only one client device 104 is shown in FIG. 1 for illustrative purposes.

The system 100 can include a plurality of provider systems 102, each operated by respective provider entities (e.g., various airlines), although only one provider system 102 is shown for illustrative purposes. The provider objects may be in any suitable format including, but not limited to Edifact recommendations in the context of Global Distribution System (GDS)-based data exchange, offer records in the context of New Distribution Capability (NDC)-based data exchange, and/or any other suitable format. Indeed, the provider objects may comprise data objects and/or data records, for example storing an Edifact recommendation or an NDC offer, and/or any other suitable data representing at least one item provided by the provider system 102.

A provider object is understood to define an item, or a combination of items, which may be offered for purchase (e.g., by end users of the items) including, but not limited to one or more of flights, train rides, hotel stays, airport lounge access, seat upgrades, baggage check services, in-flight food, entertainment, pickup services, excursion services, pet-related services, and the like, and/or associated services. Thus, in examples discussed below, a provider object may define a flight operated by the provider entity, and/or services associated with the flight, or proposed as standalone services. Each provider object therefore may contain various fields (e.g., data fields), and the like. Certain fields define item attributes, such as product object identifiers (e.g., service identifiers, item identifiers, product identifiers and the like), locations, dates and times corresponding to the products (e.g., flight times and other itinerary data). The type of fields and/or data of a provider object may depend on a type of a provider object. For example, provider objects corresponding to flights may include flight identifiers, whereas provider objects corresponding to other travel-related items, such as an offer for accessing an airport lounge and/or an offer for a premium seat upgrade, may include information related to the lounge, the premium seat, etc.

Requests for provider objects may be received at the provider system 102 from other components of the system 100. For example, the requests may be received from a client device 104, via a network 106 (e.g., any suitable combination of local and wide area networks, including the Internet) and via an intermediation server 108. As will be described below, the intermediation server 108 generally intermediates between the client device 104 and the provider system 102, for example such that the client device 104 may request products from the provider system 102 (and/or more than one provider system 102) via the intermediation server 108.

Furthermore, in some examples, the intermediation server 108 may convert data between formats associated with provider systems 102 and the client device 104. For example, a first provider system 102 may communicate and/or provide provider objects, and/or offers for provider objects, according to a first format, and a second provider system 102 may communicate and/or provide provider objects, and/or offers for provider objects, according to a second format (e.g., which may be the same or different from the first format). Neither format may be compatible with a format used by the client device 104 to communicate. As such, the intermediation server 108 may convert data received in different formats from the provider system 102, to a format compatible with the client device 104, and vice versa.

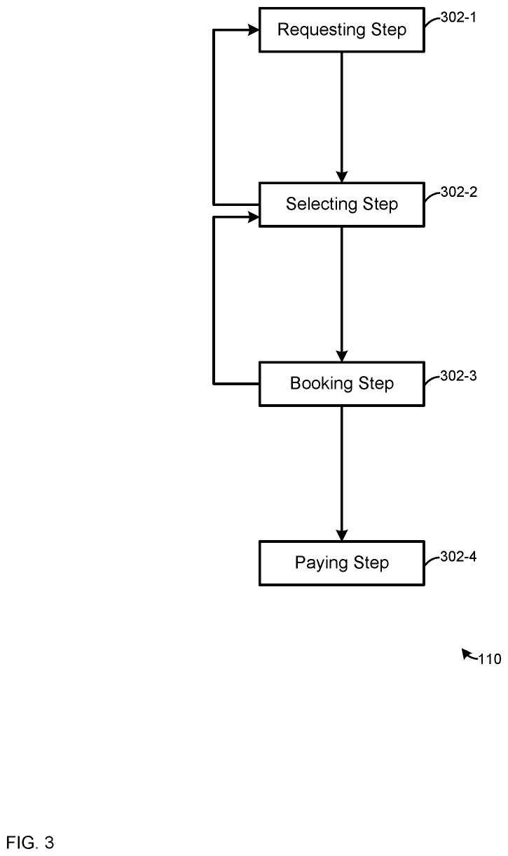

The client device 104, in the present example, may be operated by a travel agent entity, and therefore generates and provides requests for provider objects (e.g., representing products, which may be for purchase), and/or requests to purchase products (e.g., represented by the provider objects), to the provider system 102, via the intermediation server 108, on behalf of end users (e.g., travelers). However it is understood that the client device 104 may request that any suitable actions, and the like, associated the provider objects, occur, for example via the intermediation server 108, for example as described below with respect to FIG. 3.

Hence, in one example, the intermediation server 108 may comprise an aggregator server, which communicates with a plurality of provider systems 102 and aggregates provider objects and/or offers for provider objects from the plurality of provider systems 102, to provide to the client device 104. When formats of data used by the provider systems 102 and the client device 104 are compatible, the intermediation server 108 may not perform the conversions described herein when performing the aggregation functionality.

Alternatively, a client device 104 may be operated by a provider system 102. In yet another alternative, a provider system 102 may operate the intermediation server 108. Hence, it is understood that while the provider system 102, the client device 104 and the intermediation server 108 are all depicted as being separate from each other in FIG. 1, they may be associated with various combinations of one or more entities, and/or functionality of the provider system 102, the client device 104 and the intermediation server 108 may be combined in any suitable manner at one or more computing devices and/or servers and/or cloud computing devices. As such, herein, rather than refer to components of the system 100 communicating via transmitting data therebetween (e.g., such as via the network 106), herein communication between components of the system 100 is referred to as the components providing data, and the like, therebetween, which may include, but is not limited to, transmitting data over the network 106, communicating data when the components are local to each other and/or combined, and the like.

Various other mechanisms for initiating the creation of the provider objects are also contemplated. For example, end users (via the client device 104 and/or client devices and/or additional computing devices, not shown in FIG. 1) may initiate the creation of the provider objects via direct interaction with a website hosted by the intermediation server 108. Various mechanisms for the creation of provider objects will be apparent to those skilled in the art, such as the “offer” and “order” mechanisms specified by the NDC standard. However, the terms “offer” and “order” as used herein may be more generic; for example, an offer for a provider object may refer to any suitable indication of provider object that may be available, for example for purchase, while an order for a provider object may refer to any suitable request to book and/or purchase a provider object that was previously indicated as being available. Such offers and orders, and steps associated with same, are described below with respect to FIG. 3.

The client device 104 is configured to receive data contained in the provider objects via the intermediation server 108. Data obtained by the client device 104, via the intermediation server 108, may be presented to users served by the client device 104, for example via a display screen (not depicted), which may be local to the client device 104; further information associated with the items represented by the provider objects may be requested by the client device 104, which may include, but is not limited to the client device 104 ordering the items. In other words, the system 100 enables the client device 104 to request further information associated with the items represented by the provider objects, via the intermediation server 108. The client device 104 may be configured to request the further information and/or initiate such orders by providing requests to the provider system 102 via the intermediation server 108.

The provider objects provided by the provider system 102 generally include provider object data representing at least one item provided by the provider system 102. In some examples, the provider object data may include a provider object identifier and/or provider object identifier data, that identifies the provider object to the provider system 102. The provider object data may generally comprise information that identifies a travel related product and/or service. Whether the provider object data includes a specific provider object identifier, or not may depend on whether a provider object is being in an NDC or GDS format. For example, when a provider object comprises an NDC offer, the provider object identifier data may comprise an identifier generated by the provider system 102, which specifically identifies the NDC offer. However, when a provider object comprises an Edifact recommendation, which generally does not include a specific identifier, the Edifact recommendation may be identified by the provider system 102 based on provider object identifier data such as characteristics of the Edifact recommendation such as a specific order and/or format of data of the Edifact recommendation.

In general, communication between the client device 104 and the intermediation server 108 may occur via a computing-process flow 110 implemented by the client device 104, such as an Applications Programming Interface (API), and the like. For example, during offering and ordering of a provider object (e.g., booking a flight), the client device 104 may implement the computing-process flow 110 in the form of an API, and communications between the client device 104 and the intermediation server 108 may be defined by the API.

Regardless, the steps of offering and ordering a provider object may occur according to a predefined series of steps, which are discussed in more detail with respect to FIG. 3, but which may include a requesting and/or shopping step, a selecting step, a booking step and a paying step. It is understood, however, that such steps are not meant to be exhaustive, and other steps may occur in in the computing-process flow 110. However, in any of these steps, a provider object may be updated to include further items for selection that may be added to the provider object, and an operator of the client device 104 may select from the items for selection to update the provider object.

Using a travel-based example, at the requesting and/or shopping step, one or more provider objects may be generated that includes a flight and various other items for selection, such as a seat selection service, a limo service, and the like; the one or more provider objects may be generated in response to a provider object request from the client device 104 that includes criteria for searching (e.g., a date, a departure airport, an arrival airport, amongst other possibilities), and the one or more provider objects are understood to meet at least a portion of such criteria. The provider object(s) may be presented to an operator of the client device 104, for example via a display screen, and the operator of the client device 104 may select, at the selecting step, one of the provider objects that includes a respective flight, and optionally select one or more of the other items for selection causing the selected provider object to be updated. The provider object with the selected item(s) may again be presented to the operator of the client device 104 at a second selecting step, and the provider object may be further updated to include more items for selection, such as the previously presented other items for selection and/or different items for selection, such as a lounge pass. The selecting step may be repeated until the operator of the client device 104 initiates the booking step; at the booking step, the provider object may again be updated to include any previously selected items and yet further items for selection. Once a finalized set of items for the provider object is selected, the operator of the client device 104 may initiate the paying step to pay for a final updated provider object that includes the items selected at the previous steps.

For clarity and simplicity, hereafter, the provider objects provided at the steps will be referred to as a set of provider objects, with each successive provider object including at least one item selected from a previous provider object at a previous step. Hence, a provider object provided at the booking step may comprise a provider object provided at a previous requesting and/or shopping step, and/or provided at a previous selecting step, modified to include items selected at a previous step.

In some examples, there may be many different types of items that may be provided for selection at a provider object. For example, as previously mentioned, with regards to travel-related examples, such items may include, but are not limited to, train rides (e.g., at an arrival destination), hotel stays, airport lounge access, seat upgrades, baggage check services, in-flight food, entertainment, limousine and/or taxi pickup services, excursion services, pet-related services, and the like. Such a list is understood not to be exhaustive and as various provider systems 102 develop different services, the items available for selection may change over time. Furthermore, provider systems 102 may provide different services corresponding to different items for selection (e.g., services offered by different provider systems 102 may be different from one another)

Furthermore, at a display screen of the client device 104 there may be limited space for providing items for selection and hence not all available items for selection may be provided with a provider object. Furthermore, heuristically, it is understood that the items for selection may impact, which items are selected and/or whether an item is selected. Indeed, when a provider object is finalized (e.g., at the paying step), later changing the provider object may be challenging as finalized provider objects are generally stored as being finalized, for example in a database, and changes thereto may not be possible and/or attempts to add items after finalization may result in a plurality of associated provider objects (e.g., the finalized provider object and a second associated provider object that represents the later added items), which may lead to complicated database structures and/or additional memory of a database being utilized to store the plurality of associated provider objects.

To address these issues, the system 100 further comprises a provider object management computing device 112, described in more detail below, which is generally configured to receive sets of associated provider objects generated during implementation of the computing-process flow 110, and the like, to generate a trained model configured to generate one or more new provider objects that may include items for selection. For example, the items may comprise a subset of available items for selection that have a high probability and/or chance of being selected during implementation of the computing-process flow 110, which may reduce a probability of attempts to change a finalized provider object. Such a trained model may be located at the intermediation server 108 and/or at a provider system 102.

While the intermediation server 108 and the provider object management computing device 112 are depicted as being separate from one another, it is understood that functionality of the intermediation server 108 and the provider object management computing device 112 may be at least partially combined, for example in one or more servers, cloud computing devices and the like.

Alternatively, and/or in addition, functionality of a provider system 102 and the provider object management computing device 112 may be at least partially combined, for example in one or more servers, cloud computing devices and the like.

Hence, hereafter aspects of the present specification are described as being implemented at one or more computing devices, which may include any suitable combination of computing devices of the provider system 102, the intermediation server 108 and the provider object management computing device 112 (and alternatively the client device 104).

While present examples may be implemented in any suitable manner, it is further understood that, in some examples, the intermediation server 108 and/or one or more of the provider systems 102 may operate according to an NDC standard.

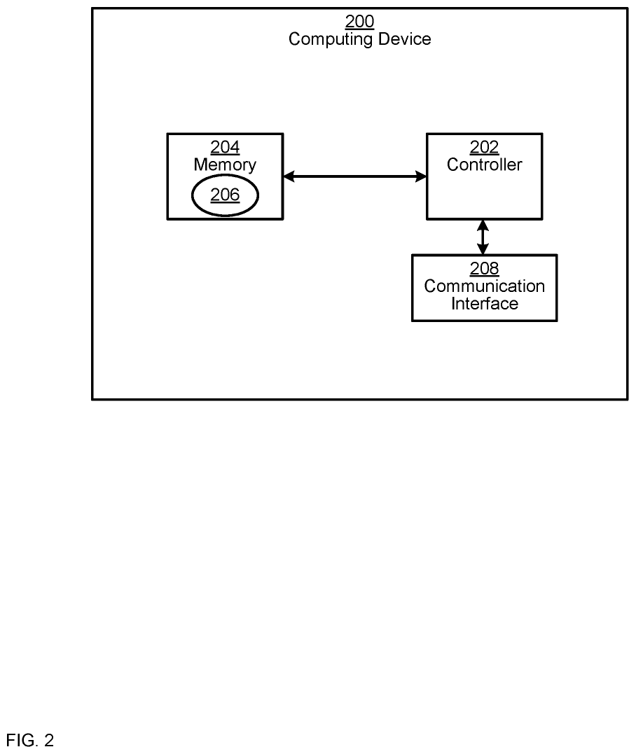

Turning to FIG. 2, before discussing the functionality of the system 100 in greater detail, certain components of a computing device 200 will be discussed in greater detail. While depicted as one device, the computing device 200 may comprise one or more computing devices and/or one or more cloud computing devices that may be geographically distributed. For example, the computing device 200 may comprise any suitable combination of computing devices of the provider system 102, the intermediation server 108 and the provider object management computing device 112 (and alternatively the client device 104).

As shown in FIG. 2, the computing device 200 includes at least one controller 202, such as a central processing unit (CPU) or the like. The controller 202 is interconnected with a memory 204 storing an application 206, the memory 204 implemented as a suitable non-transitory computer-readable medium (e.g., a suitable combination of non-volatile and volatile memory subsystems including any one or more of Random Access Memory (RAM), read only memory (ROM), Electrically Erasable Programmable Read Only Memory (EEPROM), flash memory, magnetic computer storage, and the like). The controller 202 and the memory 204 are generally comprised of one or more integrated circuits (ICs).

The controller 202 is also interconnected with a communication interface 208, which enables the computing device 200 to communicate with the other computing devices of the system 100 via the network 106, though it is understood such communication may occur locally when components of the system 100 are combined. The communication interface 208 therefore may include any necessary components (e.g., network interface controllers (NICs), radio units, and the like) to communicate via the network 106. The specific components of the communication interface 208 may be selected based on the nature of the network 106 and/or local communication between components of the system 100, and the like. The computing device 200 can also include input and output devices connected to the controller 202, such as keyboards, mice, displays, and the like (not shown).

The components of the computing device 200 mentioned above can be deployed in a single enclosure, or in a distributed format. In some examples, therefore, the computing device 200 includes a plurality of processors, either sharing the memory 204 and communication interface 208, or each having distinct associated memories and communication interfaces. As such, it is understood that the memory 204, and/or a portion of the memory 204, may be internal (e.g., as depicted) or external to the computing device 200; regardless, the controller 202 is understood to have access to the memory 204.

The memory 204 also stores a plurality of computer-readable programming instructions, executable by the controller 202, in the form of various applications, including the application 206. As will be understood by those skilled in the art, the controller 202 executes the instructions of the application 206 (and any other suitable applications) in order to perform various actions defined by the instructions contained therein. In the description below, the controller 202, and more generally the computing device 200, are said to be configured to perform those actions. It will be understood that they are so configured via the execution (by the controller 202) of the instructions of the applications stored in memory 204.

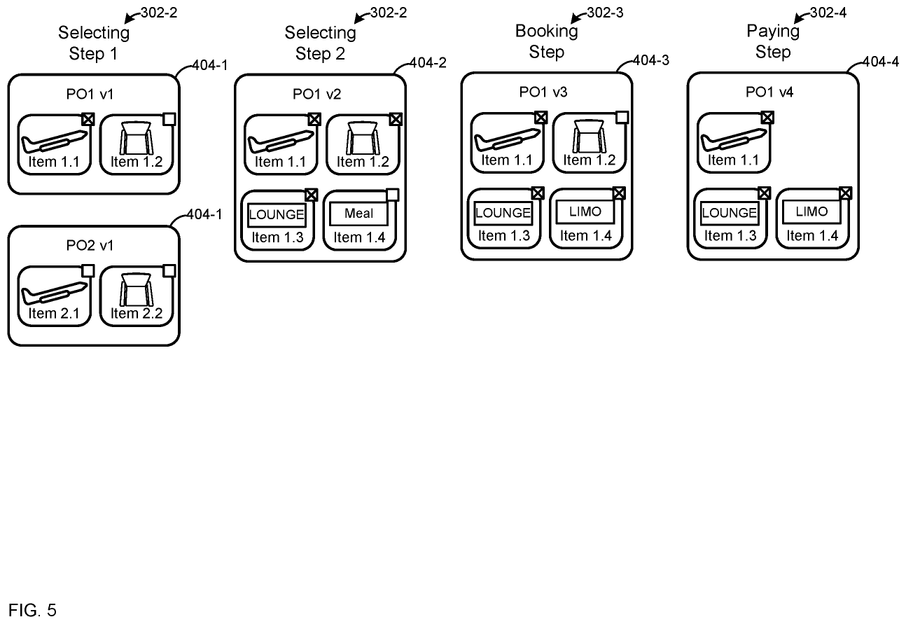

In some examples, execution of the application 206, as will be discussed below, configures the computing device 200 to implement functionality for generating trained models to generate provider objects, including but not limited to, the blocks of a method set forth in FIG. 5.

As will be described in more detail below, in some examples, the application 206 may comprise one or more machine learning algorithms trained to implement functionality for generating trained models to generate provider objects, including but not limited to, the blocks of a method set forth in FIG. 5. However, alternatively, or in addition, the application 206 may comprise one or more programmatic algorithms.

While computing devices of the provider system 102, the client device 104, and the intermediation server 108 are not described in detail, computing devices of the provider system 102, the client device 104, and the intermediation server 108 are understood to have a similar structure as the computing device 200, but adapted for respective functionality as described herein.

Attention is next directed to FIG. 3, which depicts a block diagram of an example of the computing-process flow 110. While the example computing-process flow 110 is depicted in the form of a flow chart, it is understood that the example computing-process flow 110 (e.g., hereafter the computing-process flow 110) may show steps of an application programming interface (API) that include steps 302-1, 302-2, 302-3, 302-4, hereafter interchangeably referred to, collectively, as the steps 302 and, generically, as a step 302. This convention will be used throughout the present specification. It is understood, however, that the depicted steps 302 are not meant to be exhaustive, and other steps may occur in in the computing-process flow 110.

For example, at the requesting step 302-1, a user of the client device 104 may enter criteria and/or details at data fields of a graphic user interface (GUI) used for searching for provider objects representing flights, such as a date (e.g., and time) for a flight, a departure airport, an arrival airport, among other possibilities; the criteria may be provided to the intermediation server 108, and the intermediation server 108 may provide the criteria and/or details to the provider systems 102. The provider systems 102 may return respective offers of provider objects representing flights that meet the criteria and/or details. In general, such offers of provider objects may be customized based on options associated with a provider system 102. The intermediation server 108 may aggregate offers of provider objects from a plurality of provider systems 102 and return the offers of provider objects to the client device 104. In NDC-based data exchanges, it is understood that the offers may be identified by respective offer identifiers (e.g., which may be referred to as Offends and/or an OfferID).

At the selecting step 302-2, a list of offers of the provider objects representing the flights returned by the provider systems 102, via the intermediation server 108, may be provided in a GUI at a display screen associated with the client device 104, and from which a user of the client device 104 may select, for example, a flight to book; in some examples, the user of the client device 104 may select electronic buttons, selection boxes, and the like to select items to be added to an offer and/or a provider object, as has been previously described, for example to generate an updated and/or successive provider object.

At the selecting step 302-2, the client device 104 may request a “firm” offer for the selected provider object, such as a “firm” and/or finalized price, which may be different from a “published” price. Alternatively, the requesting step 302-1 and the selecting step 302-2 may be repeated to further request and/or further select further items to generate a further updated and/or successive provider object before a “firm” offer for an updated and/or successive provider object is requested. Any suitable exchanges of data via the network 106 between the client device 104, the intermediation server 108, and the provider system 102 are understood to occur to select, request and receive the firm offer of the provider object, however such data exchanges are understood to be based on the aforementioned offer identifiers when such data exchanges comprise NDC-based data exchanges (e.g., using an offer identifier of a selected offer).

Similarly, at the booking step 302-3, information for a selected provider object, such as the aforementioned flight, may be provided in a GUI at a display screen, and from which a user of the client device 104 may select electronic buttons to pay for and/or order the flight, and/or to add a service to a booking, such as a pickup service, and the like. As such, alternatively, the selecting step 302-2 may be repeated to further select further items to generate a further updated and/or successive provider object to again request a “firm” offer for the updated and/or successive provider object. Any suitable exchanges of data via the network 106 between the client device 104, the intermediation server 108, and the provider system 102 are understood to occur to book and/or order the firm offer of the for an updated and/or successive provider object however such data exchanges are understood to be based on the aforementioned offer identifiers when such data exchanges comprise NDC-based data exchanges. In NDC-based data exchanges, it is understood that the orders may be identified by respective order identifiers (e.g., which may be referred to as OrderIds and/or an OrderID).

Similarly, at the paying step 302-4, fields for entering payment information, such as credit card information, to pay for a selected flight being booked may be provided in a GUI at a display screen. Any suitable exchanges of data via the network 106 between the client device 104, the intermediation server 108, and the provider system 102 are understood to occur to pay for the firm offer for the updated and/or successive provider object. It is understood that the term “order” as used herein may refer to a booking of an offer, and which may include an offer that is only booked, but not yet paid for, or an order, which is booked and paid for, depending on which steps 302 of the computing-process flow 110 have been implemented.

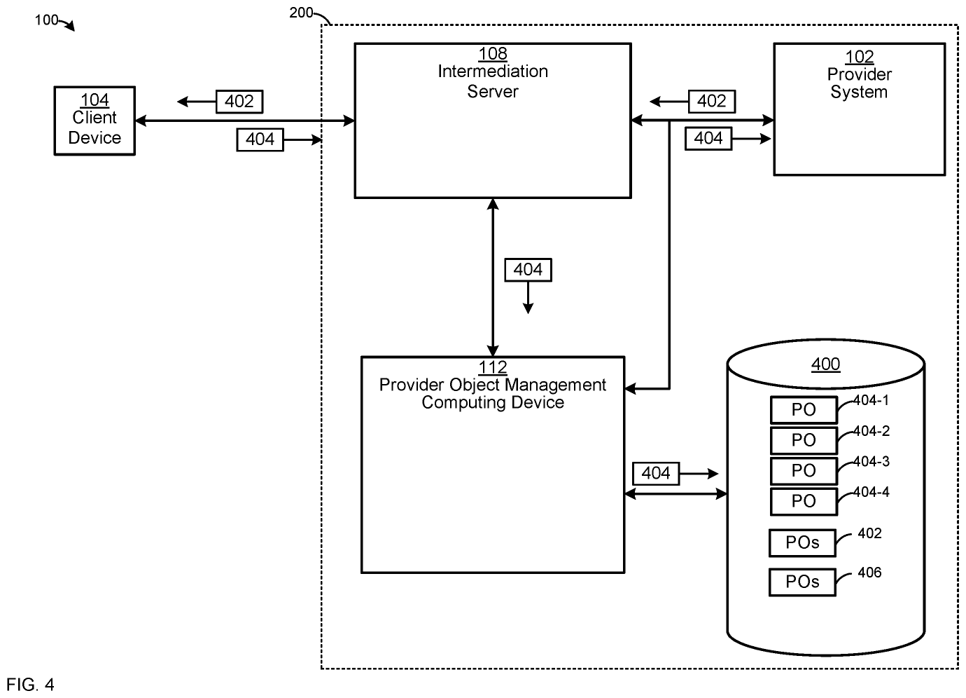

Attention is now directed to FIG. 4, which illustrates one example of the system 100 that includes one provider system 102, one client device 104, and the intermediation server 108 intermediating therebetween, as well as the provider object management computing device 112. While the network 106 is not depicted, it is nonetheless understood to be present. For example, communication links between components of the system 100 are depicted in FIG. 4, and throughout the present specification, as double-ended arrows between respective components; the communication links may include any suitable combination of wireless and/or wired links and/or wireless and/or wired communication networks including, but not limited to, the network 106.

In particular, as depicted, the provider object management computing device 112 is in communication with the provider system 102 and the intermediation server 108.

Furthermore, as depicted, the computing device 200 is depicted in dashed lines around the provider system 102, the intermediation server 108 and the provider object management computing device 112 indicating that functionality of the computing device 200 may be implemented at one or more computing devices of the provider system 102, the intermediation server 108 and the provider object management computing device 112 (and, while not depicted, the client device 104). Hence, while hereafter, certain components are described as having certain functionality it is understood that such functionality may be shared amongst any suitable components of the system 100.

As depicted, in conjunction with implementing the computing-process flow 110, the provider system 102 is providing, via the intermediation server 108, to the client device 104, provider objects 402, which may include items for selection, as described in more detail below. The client device 104 returns provider objects 404 to the provider system 102, via the intermediation server 108, that comprise the provider objects 402 modified to include items selected via the client device 104. The provider objects 404 are understood to comprise a set of associated provider objects 404 and in particular, the set of associated provider objects 404 are understood to be received not at the same time, but successively in time as successive provider objects 402 are provided to the client device 104 in the computing-process flow 110, and the resulting corresponding successive provider objects 404 are received from the client device 104.

Furthermore, provider objects received at the intermediation server 108 may include other sets of provider objects 406 received from other client devices 104, and the like, and/or the sets of provider objects 406 received at the intermediation server 108 may include other sets of provider objects received from the depicted client device 104, but generated in conjunction with other sets of provider objects generated by the provider system 102 and/or in conjunction with other implementations of the computing-process flow 110.

As depicted, the set of associated provider objects 404 are also provided to the provider object management computing device 112 for storage in a memory 400, to which the provider object management computing device 112 has access. While depicted in the form of a database, the memory 400 may comprise one or more suitable memories 400. The memory 400, which may be referred to hereafter interchangeably as one or more memories 400, may be separate from the memory 204 and/or at least partially integrated with the memory 204.

As depicted, the memory 400 stores the set of associated provider objects 404, which, as depicted, comprise four provider objects 404-1, 404-2, 404-3, 404-4, described in more detail with respect to FIG. 5. It is further understood that the set of associated provider objects 404 may be stored with one or more identifies that identify one or more of: an operator and/or user of the client device 104 that was logged into the client device 104 when the set of associated provider objects 404 were generated and/or received; a location of the client device 104; a date and/or time when the set of associated provider objects 404 were generated and/or received; and/or any other suitable identifiers that identify a context and/or associated information indicating conditions and/or criteria, in which the set of associated provider objects 404 were generated and/or received.

Such context and/or associated information indicating conditions and/or criteria may include, but is not limited, to demographics of operators and/or users of the client device 104 when the set of associated provider objects 404 were generated and/or received. Such demographics may include an age and/or sex (e.g., male, female, non-binary) and/or type (e.g., business travelers, leisure travelers, backpacker travelers, and the like) of the operators and/or users of the client device 104. For example, operators and/or users of the client device 104 may be associated with respective records that may be stored at the memory 400, or another memory 400, that include such demographic information.

For completeness, the memory 400 is depicted as storing the aforementioned other sets of provider objects 406, as well as the original provider objects 402.

Attention is next directed to FIG. 5, which depicts a graphical representation of details of the provider objects 404-1, 404-2, 404-3, 404-4, which may be provided at a display screen of the client device 104. In particular, in FIG. 5, it is assumed there are two selecting steps 302-2 of the computing-process flow 110 that were implemented, and furthermore each provider object 404 includes items for selection, which are numbered as item x.y, where “x” comprises an identifier (e.g., “1” or “2”) of one of two provider objects 404-1 provided at the first selecting step 302-2, and “y” comprises an identifier (e.g., “1”, “2” . . . ) of various associated items for selection of a particular provider object 404. While the items are depicted with identifying graphics or text, the items may include any suitable information including, but not limited to, respective prices thereof, details of associated flights, and the like.

Furthermore, while each item depicted is understood to represent one respective service, and the like, in other examples, a given item may represent more than one service and the like (e.g., such as a combination of a flight and seat selection, a combination of a lounge pass and a limousine pick up service, among other possibilities).

For example, as depicted, the first selecting step 302-2 (“Selecting Step 1”) includes two provider objects 404-1, also labelled “PO1 v1” and “PO2 v1”, representing at least flights provided by same or different provider systems 102. The first provider object 404-1 (PO1 v1) includes two items 1.1, 1.2 respectively representing a flight (e.g., as represented by an icon and/or graphic of an airplane) and a seat selection service (e.g., as represented by an icon and/or graphic of a seat). Similarly, the second provider object 404-1 (PO2 v1) includes two items 2.1, 2.2 respectively representing a respective flight and a respective seat selection service. Both of the flights may meet criteria provided by the client device 104 during the requesting step 302-1 (e.g., such as a date, a departure airport and a destination airport).

The notation of “PO1 v1” and “PO2 v1” is understood to refer to an identifier (e.g., “PO #”) of a provider object and a version (e.g., “v #”) of a respective provider object. Hence, for example, “PO1 v1” may refer to a first (“v1”) version of a first (“PO1”) provider object 404, and “PO2 v1” may refer to a first (“v1) version of a second (“PO2”) provider object 404. Other and/or successive versions of the provider objects 404 are labelled as “v2”, “v3” etc. However, such notation is used merely for convenience and is but one example of possible identifiers of the provider objects 404.

As depicted, the item 1.1 of the first provider object 404-1 (PO1 v1) is selected, indicated by an “X” in an associated selection box; however, the item 1.2 is not selected, indicated by an absence of an “X” in an associated selection box. However, such selection boxes are but one example of a mechanism for selecting, at the client device 104, items of provider objects 404 and any suitable mechanism for selecting items is within the scope of the present specification, including, but not limited to, electronic buttons. It is understood that such a selection may occur via an operator of the client device 104 using an input device (e.g., a mouse, and the like), of the client device 104.

As depicted, no items of the second provider object 404-1 (PO2 v1) are selected, and the client device 104 is understood to return the provider objects 404-1 to the provider system 102 (e.g., via the intermediation server 108) showing the selections of the items and/or showing the selection of the first provider object 404-1 (PO1 v1) but not the second provider object 404-1 (PO2 v1). In some instances, the second provider object 404-1 (PO2 v1) that includes no items selected may not be returned to the provider system 102, and/or provider objects 404 that do not correspond to provider objects 402 generated by the provider system 102 are not returned to the provider system 102 (e.g., provider objects 404 may only be provided to a provider system 102 that generated the initial corresponding provider object 402 so that a provider system 102 is not exposed to provider objects 402, 404 associated with other provider systems 102).

At the second selecting step 302-2 (“Selecting Step 2), it is understood that a second version (“v2”) of the first provider object 404-1 is provided as the provider object 404-2, which comprises the item 1.1 selected at the previous selecting step 302-2, as well other items for selection. As depicted, such other items for selection include the item 1.2, as well as an item 1.3 corresponding to a lounge pass and an item 1.4 corresponding to a meal (e.g., on the flight).

The provider object 404-2 is hence understood to comprise the first previous provider object 404-1 (e.g., PO1 v1) that includes previous items selected, as well as further items for selection, though the further items for selection may include items not previously selected (e.g., such as the item 1.2).

In some examples, when items not previously selected are again provided for selection, a price of such items may change (e.g., decrease in price, though increases in price are also within the scope of the present specification).

As depicted, the items 1.1, 1.2, 1.3 are selected at the provider object 404-2.

At the booking step 302-3, (“Booking Step), it is understood that a third version (“v3”) of the first provider object 404-1 is provided as the provider object 404-3, which comprises the items 1.1, 1.2, 1.3 selected at the previous second selecting step 302-2, as well another item 1.4 for selection, in particular a limousine pickup service. At the provider object 404-3 it is understood that the item 1.2 that was previously selected has been unselected, and the new item 1.4 has been selected, while the items 1.1, 1.2 remain selected. It is understood that at least the item 1.1 may not be deselected as the services represented by the other items 1.1, 1.2, 1.3, 1.4 are generally provided in conjunction with the item 1.1 (e.g., the flight).

At the paying step 302-4, a finalized version (“v4”) of the first provider object 404-1 is provided as the provider object 404-4, for example for payment, and the provider object 404-4 comprises the items 1.1, 1.3, 1.4 selected at the booking step 302-3.

In general, it is understood that the set of provider objects 404 depicted in FIG. 5 represent a history of how the finalized provider object 404-4 evolved from previous provider objects 404 (and/or previous provider objects 402), and hence may be used to train a model, such as a machine learning model, on how to later provide provider objects, such that the model predicts items that are most likely to be selected and generates and/or adapts provider objects accordingly. Indeed, as more sets of associated provider objects 404 are received, the model may continue to be updated such that the model may become more accurate over time.

It is further understood that the set of provider objects 404 depicted in FIG. 5 may generally be associated with each other, and/or linked together, for example as a successive provider object 404 is generated from a previous provider object 404 in a given implementation of the computing-process flow 110. Such an association may occur via the set of provider objects 404 depicted in FIG. 5 being associated with an identifier identifying the set of provider objects 404 depicted in FIG. 5 as being linked together. For example, it is understood that the provider object 404-4 may be linked and/or associated with the provider object 404-3 as the provider object 404-4 is generally generated from the provider object 404-3 in an implementation of the computing-process flow 110; similarly, the provider object 404-3 may be linked and/or associated with the provider object 404-2 as the provider object 404-3 is generally generated from the provider object 404-2 in the implementation of the computing-process flow 110; similarly, the provider object 404-2 may be linked and/or associated with the provider object 404-1 as the provider object 404-2 is generally generated from the provider object 404-1. Such associations between a previous and a next provider object 404 of a given implementation of the computing-process flow 110 may be indicated in any suitable manner using an identifier and/or more than one identifier. Put yet another way, the set of provider objects 404 depicted in FIG. 5 may be associated using one or more identifiers, and the one or more identifiers may further indicate one or more of a step of the computing-process flow 110, at which a provider object 404 was generated, and a relationship and/or order between pairs of a previous and next provider object 404, that further indicate a history of when each provider object was generated in relation to steps of the computing process flow 110. For example, the identifiers “PO1 v1”, “PO1 v2”, “PO1 v3”, “PO1 v4” indicate that the set of provider objects 404 depicted in FIG. 5 all belong to a same set via the indicator “PO1” and the version number indicates an order of the provider objects 404.

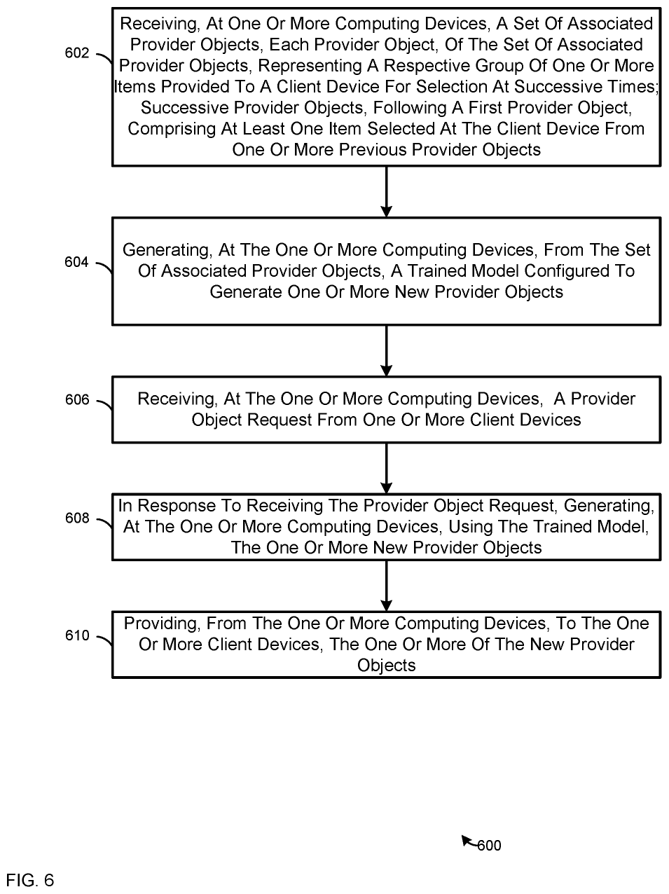

Attention is now directed to FIG. 6, which depicts a flowchart representative of a method 600 a method for generating trained models to generate provider objects. The operations of the method 600 of FIG. 6 correspond to machine readable instructions that are executed by one or more of the computing devices 200, and specifically by one or more controllers 202 of the one or more computing devices 200. In the illustrated example, the instructions represented by the blocks of FIG. 6 are stored at the memory 204 (and/or one or more memories 204) for example, as the application 206. The method 600 of FIG. 6 is one way in which the controller(s) 202 and/or the computing device(s) 200 and/or the system 100 may be configured. Furthermore, the following discussion of the method 600 of FIG. 6 will lead to a further understanding of the system 100, and its various components.

The method 600 of FIG. 6 need not be performed in the exact sequence as shown and likewise various blocks may be performed in parallel rather than in sequence. Accordingly, the elements of method 600 are referred to herein as “blocks” rather than “steps.” The method 600 of FIG. 6 may be implemented on variations of the system 100 of FIG. 1 and FIG. 4, as well.

It is understood that the method 600 may generally result in the client device 104 and/or the intermediation server 108 and/or the provider system 102 reducing usage of processing resources and/or bandwidth in at least in a reduction in a number of the selecting steps 302-2 and/or in a reduction of changes to provider objects.

At a block 602, the controller 202, and/or one or more computing devices 200, receive (e.g., via the communication interface 208) a set of associated provider objects, each provider object, of the set of associated provider objects, representing a respective group of one or more items provided to a client device for selection at successive times; successive provider objects, following a first provider object, comprising at least one item selected at the client device from one or more previous provider objects.

For example, the set of associated provider objects may comprise the set of associated provider objects 404 described herein, for example as received from the client device 104. However, the set of associated provider objects may alternatively, and/or additionally, comprise the set of associated provider objects 402, as received from the provider system 102.

Regardless, each provider object of the block 602 is understood to represent a respective group of one or more items provided to a client device 104 for selection at successive times, similar to as described with respect to FIG. 5. Similarly, successive provider objects, following a first provider object (e.g., the provider objects may be successive in time), are understood to comprise at least one item selected at the client device 104 from one or more previous provider objects, such as the items 1.1, 1.2, 1.3, 1.4 described with respect to FIG. 5.

Put another way, in some examples, the set of associated provider objects of the block 602 may comprise respective provider objects that are one or more of provided to (e.g., the provider objects 402), and received from (e.g., the provider objects 404), the client device 104 at different steps of the computing-process flow 110 implemented by the client device 104.

Furthermore, in some examples, receiving the set of associated provider objects at the block 602 may comprise receiving the set of associated provider objects successively. In particular, the associated provider objects may be received successively in time.

Furthermore, in some examples, at least one item selected at the client device 104 from one or more previous provider objects comprises a first item selected at the client device 104 from one or more previous provider objects, and at least one of the successive provider objects, following the first provider object, further comprises: the first item selected at the client device 104 from one or more previous provider objects (e.g., such as a flight); and one or more further items for selection at the client device 104 (e.g., such as a seat selection service, a lounge pass, a meal, and the like). This example is understood to be illustrated with respect to FIG. 5.

At a block 604, the controller 202, and/or one or more computing devices 200, generate, from the set of associated provider objects, a trained model configured to generate one or more new provider objects.

For example, the trained model may comprise one or more of a machine learning model, a classifier of the machine learning model and a neural network layer. Put another way, the set of associated provider objects received at the block 602 may be used to train, in a training mode, one or more of a machine learning model, a classifier of the machine learning model and a neural network layer, where a first provider object that has selectable items is used as input, and a second provider object, which comprises the first provider object but with one or more of the selectable items being selected, as output. The trained model may be updated as more sets of associated provider objects are received, and/or trained model may be updated periodically, for example using a plurality of previously received sets of associated provider objects.

Put another way, the method 600 may further comprise, the controller 202, and/or one or more computing devices 200: receiving a plurality of sets of respective associated provider objects, including the set of associated provider objects (e.g., received at the block 602; and generating the trained model from the plurality of sets of respective associated provider objects.

Furthermore, the trained model may be trained for different steps 302 of the computing-process flow 110, such that the trained model may output different provider objects, depending on which step 302 of the computing-process flow 110 is being implemented. Hence, for example, the trained model may be further trained using an identifier of an associated step 302 of the computing-process flow 110, as input with a respective provider object.

Furthermore, the trained model may be trained with respect to other criteria, such as a location of client devices 104, demographics of operators of the client devices 104, as described above, such that the trained model may output different provider objects depending on demographics of an operator and/or user of the client device 104. Hence, for example, the trained model may be further trained using identifiers of demographics of an operator and/or user of the client device 104, as input with a respective provider object.

Such examples illustrate the that the trained model may be trained using any suitable input, which may further include a location associated with a client device 104, times and/or dates at which provider objects were generated and/or received, and the like. Indeed, in some examples, the trained model may be trained specific to a given operator and/or user of the client device 104.

As such, it is understood that the trained model may comprise a plurality of trained models, which may be specific to given demographics and/or locations and/or locations and/or times/dates and/or given operators and/or users of the client device 104.

Furthermore, in some examples, the trained model may be trained to generate up to a maximum of a given number of items for selection for a provider object, for example due to possible limitations of display screen size at the client device 104, though any suitable number of given number of items for selection is within the scope of the present specification.

At a block 606, the controller 202, and/or one or more computing devices 200, receives (e.g., via the communication interface 208) a provider object request from one or more client devices 104.

For example, via the requesting step 302-1 of the computing-process flow 110, the client device 104 of FIG. 4, or another client device 104, may initiate another search for a flight, and/or any other suitable item that may be represented by a provider object, and provide a provider object request that includes criteria for performing the search, the provider object request received at the provider system 102, for example via the intermediation server 108.

While heretofore provider objects are described as being generated by the provider system 102, in other examples, a provider object may be generated, at least at the requesting step 302-1 and the selecting step 302-2, by the intermediation server 108. For example, the intermediation server 108 may maintain a cache and/or list of flights, and/or other items, provided the provider system 102, and, to minimize communications with the provider system 102, the intermediation server 108 may be configured to generate a provider object from such a cache and/or list.

Hence, it is understood that the provider system 102 and/or the intermediation server 108 may respond to a provider object request from one or more client devices 104. As such, the trained model may be maintained at the provider system 102 and/or the intermediation server 108

At a block 608, the controller 202, and/or one or more computing devices 200, in response to receiving the provider object request, generate using the trained model, the one or more new provider objects.

It is understood that the block 608 may include the controller 202, and/or one or more computing devices 200 initially generating a provider object that meets the criteria of the provider object request and then using the initially generated provider object as input to the trained model (e.g., along with demographic information, and the like, as described herein) to generate a provider object that includes the initially generated provider object with other items for selection added thereto. However, in other examples, the trained model may be further trained to generate a provider object that includes the items for selection on using the provider object request as input, at least at the requesting step 302-1.

Furthermore, the trained model may be further configured to generate one or more of: a respective first provider object of a new set of the one or more new provider objects; and one or more further successive provider objects of the new set of the one or more new provider objects. Put another way, the trained model may be configured to generate a provider object that is provided to the client device 104 at the requesting step 302-1, as well as successive provider objects that is provided to the client device 104 at the selecting step(s) 302-2, the booking step 302-3 and the paying step 302-4.

As such, the trained model may be further configured to generate one or more new groups of one or more respective items for incorporation into one or more of the new provider objects, such as new items for selection.

At a block 610, the controller 202, and/or one or more computing devices 200, provide, from the one or more computing devices 200 (e.g., via the communication interface 208), to the one or more client devices 104, the one or more of the new provider objects.

For example, the one or more of the new provider objects may be provided successively to the one or more client devices 104 as the steps 302 of the computing-process flow 110 are successively implemented at the one or more client devices 104.

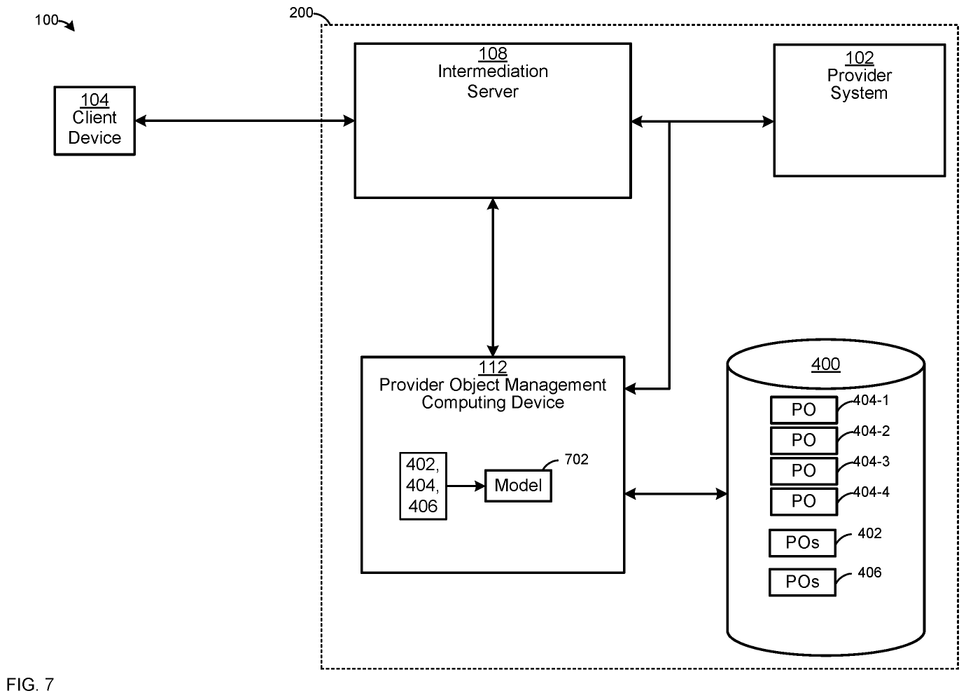

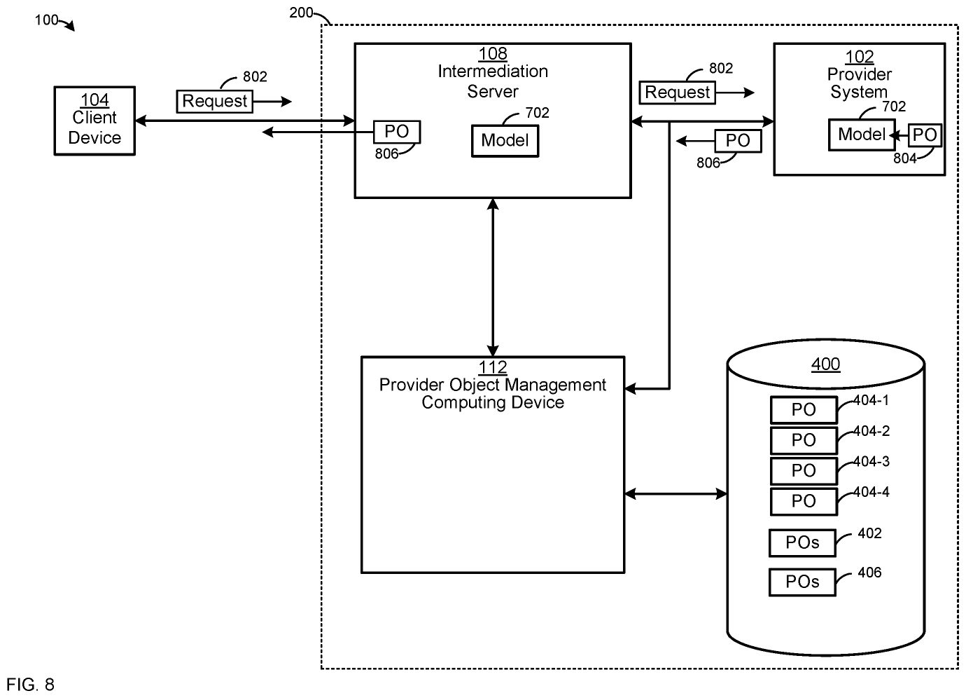

An example of aspects of the method 600 is next describe with reference to FIG. 7 and FIG. 8, which are substantially similar to FIG. 4, with like components having like numbers. At FIG. 7 and FIG. 8, it is understood that a set of associated provider objects 402, 404, 406 has been received, and/or sets of associated provider objects 402, 404, 406 have been received at the block 602 of the method 600, for example as depicted in FIG. 4. FIG. 4 may be understood to show an illustration of the block 602 of the method 600.

With attention is first directed to FIG. 7, the various sets of associated provider objects 402, 404, 406 are used to generate a trained model 702 (e.g., at the block 604 of the method 600) at the provider object management computing device 112. Suitable provider objects 402, 404, 406 are used as training input while other suitable provider objects 402, 404, 406 are used as training output. For example, a previous provider object 402, 404, 406 of a given set may be used as training input, and a next successive provider object 402, 404, 406 of the given set may be used as corresponding training output.

While not depicted, in some examples, previous provider object requests may be used as training input, while resulting provider objects 402, 404, 406 may be used as training output.

As depicted, the generation of the trained model 702 is occurring at the provider object management computing device 112, and the trained model 702 may be provided to one or more of the intermediation server 108 and the provider system 102. However, in other example, the trained model 702 may be implemented at one of the intermediation server 108 and the provider system 102.

However generation of the trained model 702 may occur at one or more of the intermediation server 108 and the provider system 102.

However, for generation of the trained model 702 to occur at the provider system 102, the provider objects 402, 404, 406 are understood to be provided to the provider system 102, which may include provider objects 402, 404, 406 not generated by the provider system 102. As this scenario may not be permitted (e.g., due to rules and/or agreements between an entity associated with the intermediation server 108 and entities associated with the provider systems 102), in some examples, generation of the trained model 702 may occur at the provider object management computing device 112 and/or the intermediation server 108, and the trained model 702 may be provided to the provider system 102.

However, in other examples, provider objects 402, 404, 406 provided to the provider system 102 may exclude provider objects 402, 404, 406 not generated by the provider system 102, such that the version of the trained model 702 implemented by the provider system 102 is specific to the provider system 102.

It is further understood that the trained model 702 implemented by the intermediation server 108 may also be specific to the provider system 102, and/or the trained model 702 may be trained using identifiers of provider systems 102 that provided the provider objects 402, 404, 406. Such training may obviate the trained model 702 generating provider objects with selectable items that may represent services, and the like, that are not provided by a provider system 102 that provides another item of a provider system, such as a flight. Put another way, provider objects generated by the trained model 702, that represent a flight, and the like, provided by a provider system 102, are understood to exclude items for selection not offered by the provider system 102.

Attention is next directed to FIG. 8, which depicts the trained model 702 being implemented at the provider system 102. As such, it is understood that the provider object management device 112 has provided the trained model 702 to the provider system 102. While the trained model 702 is also present at the intermediation server 108 (e.g., the provider object management device 112 has also provided the trained model 702 to the intermediation server 108), in this example, the intermediation server version of the trained model 702 is not used.

As depicted, the intermediation server 108 receives a provider object request 802 from the client device 104, and forwards the provider object request 802 to the provider system 102, which receives the provider object request 802 (e.g., at the block 606 of the method 600). The provider object request 802 may be received in conjunction with the requesting step 302-1 of the computing-process flow 110.

The provider system 102 generates a provider object 804 that represents an item that matches (or partially matches) criteria received in the provider object request 802, and uses the provider object 804 as input to the trained model 702, which may be provided along with an identifier of the requesting step 302-1 and/or any other suitable information, such as an identifier and/or location of the client device 104 and/or an operator and/or user thereof and/or any other suitable demographic information (e.g., which may be received in conjunction with the provider object request 802 and/or retrieved from a memory and/or record), and/or an identifier of the step 302 of the computing-processing flow 110 being implemented (e.g., an identifier of the requesting step 302-1).

As such, using the trained model 702, the provider system 102 generates (e.g., at the block 608 of the method 600) a provider object 806 that comprises the provider object 804 and one or more items for selection, similar to the provider objects 404 as depicted in FIG. 5. The provider object 806 is provided (e.g., at the block 610 of the method 600) to the client device 104 in response to the provider object request 802, and via the intermediation server 108.

Alternatively, the intermediation server 108 may generate the provider object 806 using the trained model 702. Alternatively, the intermediation server 108 may generate the provider object 804, and use the provider object 804 and the trained model 702 to generate the provider object 804.

Indeed, any suitable combination of computing devices 200 may be used to implement the method 600.

As should by now be apparent, the operations and functions of the devices described herein are sufficiently complex as to require their implementation on a computer system, and cannot be performed, as a practical matter, in the human mind. In particular, computing devices, and the like, such as set forth herein are understood as requiring and providing speed and accuracy and complexity management that are not obtainable by human mental steps, in addition to the inherently digital nature of such operations (e.g., a human mind cannot interface directly with, RAM or other digital storage, cannot transmit or receive electronic messages, among other features and functions set forth herein).

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, XZ, and the like). Similar logic can be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that in some examples, the functionality of devices and/or methods and/or processes described herein can be implemented using pre-programmed hardware or firmware elements (e.g., application specific integrated circuits (ASICs), electrically erasable programmable read-only memories (EEPROMs), etc.), or other related components. In other examples, the functionality of the devices and/or methods and/or processes described herein can be achieved using a computing apparatus that has access to a code memory (not shown), which stores computer-readable program code for operation of the computing apparatus. The computer-readable program code could be stored on a computer readable storage medium, which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative examples and modifications possible, and that the above examples are only illustrations of one or more examples. The scope, therefore, is only to be limited by the claims appended hereto.

What is claimed is:

1. A method comprising:
receiving, at one or more computing devices, a set of associated provider objects, each provider object, of the set of associated provider objects, representing a respective group of one or more items provided to a client device for selection at successive times; successive provider objects, following a first provider object, comprising at least one item selected at the client device from one or more previous provider objects; and
generating, at the one or more computing devices, from the set of associated provider objects, a trained model configured to generate one or more new provider objects;
receiving, at the one or more computing devices, a provider object request from one or more client devices;
in response to receiving the provider object request, generating, at the one or more computing devices, using the trained model, the one or more new provider objects; and
providing, from the one or more computing devices, to the one or more client devices, one or more of the new provider objects.

2. The method of claim 1, wherein the set of associated provider objects comprises respective provider objects provided to the client device at different steps of a computing-process flow implemented by the client device.

3. The method of claim 1, wherein the set of associated provider objects comprises respective provider objects provided to the client device at different steps of a computing-process flow implemented by the client device, the set of associated provider objects associated with each other using one or more identifiers.

4. The method of claim 1, wherein at least one item selected at the client device from one or more previous provider objects comprises a first item selected at the client device from one or more previous provider objects, and at least one of the successive provider objects, following the first provider object, further comprises: the first item selected at the client device from one or more previous provider objects; and one or more further items for selection at the client device.

5. The method of claim 1, wherein the trained model comprises one or more of a machine learning model, a classifier of the machine learning model and a neural network layer.

6. The method of claim 1, further comprising:
receiving a plurality of sets of respective associated provider objects, including the set of associated provider objects; and
generating the trained model from the plurality of sets of respective associated provider objects.

7. The method of claim 1, wherein the trained model is further configured to generate one or more of:
a respective first provider object of a new set of the one or more new provider objects; and
one or more further successive provider objects of the new set of the one or more new provider objects.

8. The method of claim 1, wherein the trained model is further configured to generate one or more new groups of one or more respective items for incorporation into one or more of the new provider objects.

9. A device comprising:
a communication interface; and
a controller configured to:
receive, via the communication interface, a set of associated provider objects, each provider object, of the set of associated provider objects, representing a respective group of one or more items provided to a client device for selection at successive times; successive provider objects, following a first provider object, comprising at least one item selected at the client device from one or more previous provider objects; and
generate, from the set of associated provider objects, a trained model configured to generate one or more new provider objects;
receive, via the communication interface, a provider object request from one or more client devices;
in response to receiving the provider object request, generate, at the one or more computing devices, using the trained model, the one or more new provider objects; and
provide, via the communication interface, to the one or more client devices, one or more of the new provider objects.

10. The device of claim 9, wherein the set of associated provider objects comprises respective provider objects provided to the client device at different steps of a computing-process flow implemented by the client device.

11. The device of claim 9, wherein the set of associated provider objects comprises respective provider objects provided to the client device at different steps of a computing-process flow implemented by the client device, the set of associated provider objects associated with each other using one or more identifiers.

12. The device of claim 9, wherein at least one item selected at the client device from one or more previous provider objects comprises a first item selected at the client device from one or more previous provider objects, and at least one of the successive provider objects, following the first provider object, further comprises: the first item selected at the client device from one or more previous provider objects; and one or more further items for selection at the client device.

13. The device of claim 9, wherein the trained model comprises one or more of a machine learning model, a classifier of the machine learning model and a neural network layer.

14. The device of claim 9, wherein the controller is further configured to:
receive a plurality of sets of respective associated provider objects, including the set of associated provider objects; and
generate the trained model from the plurality of sets of respective associated provider objects.

15. The device of claim 9, wherein the trained model is further configured to generate one or more of:
a respective first provider object of a new set of the one or more new provider objects; and
one or more further successive provider objects of the new set of the one or more new provider objects.

16. The device of claim 9, wherein the trained model is further configured to generate one or more new groups of one or more respective items for incorporation into one or more of the new provider objects.
